(19) United States
(12) Patent Application Publication
(10) Pub. No.: US 2018/0294763 A1
(43) Pub. Date: Oct. 11, 2018

(54) Solar Module Mounting Apparatus

(71) Applicant: Benjamin Graves, Charleston, SC (US)

(72) Inventor: Benjamin Graves, Charleston, SC (US)

(21) Appl. No.: 15/483,287

(22) Filed: Apr. 10, 2017

(51) Int. Cl. H02S 20/23; F16M 13/02; H02S 30/00; F24J 2/04

(52) U.S. Cl. CPC H02S 20/23; F24J 2/045; H02S 30/00; F16M 13/022

(57) ABSTRACT

A solar module mounting apparatus for mounting a solar collection module to a roof includes a rail member having an elongate linear configuration and having first and second ends, the rail member defining a channel extending between the first and second ends that defines an open top configured to mate with a mounting flange of a rooftop solar collection module. The mounting apparatus includes a strap assembly that includes (1) a first strap portion having a proximal end coupled to the first end of the rail member and a distal end operatively coupled to the wall structure remote from the roof and (2) a second strap portion having a proximal end coupled to the second end of the rail member and a distal end operatively coupled to one of a ridgeline of the roof or another wall structure remote from the roof

### BACKGROUND OF THE INVENTION

This invention relates generally to roof mounted roof mounted solar collection devices and, more particularly, to a solar module mounting apparatus that positions one or more solar module supporting rails on a roof without any invasive, roof-damaging fasteners being driven into the roof.

The usage and popularity of using solar energy collection panels on residential and commercial building has been steadily rising over recent years as the cost of purchasing solar panels decreases and the efficiency of converting collected energy into electricity improves. In fact, more municipalities and planning committees are taking note of the increased usage of this energy source and formulating needed regulations. There is an indirect cost, however, that is often overlooked when considering installation of a solar collection system on one's roof. Namely, most solar energy collection systems are mounted with fasteners that puncture through the roofing material, e.g. with screws, anchor bolts, and the like. The unfortunate result is that the roof is at a heightened, if not certain, risk of water leakage and damage to property.

Therefore, it would be desirable to have a solar module mounting apparatus that secures solar module mounting rails to a roof without any invasive fasteners penetrating roofing materials. Further, it would be desirable to have a solar module mounting apparatus that secures respective mounting rails to a roof using a strap assembly secured to an exterior of a wall structure remote from the roof itself. In addition, it would be desirable to have a solar module mounting apparatus in which mounting flanges associated with a solar module include a spring loaded (push-button) configuration.

### SUMMARY OF THE INVENTION

A solar module mounting apparatus for mounting a solar collection module to a roof according to the present invention includes a rail member having an elongate linear configuration and having first and second ends, the rail member defining a channel extending between the first and second ends that defines an open top configured to mate with a mounting flange of a rooftop solar collection module. The mounting apparatus includes a strap assembly that includes (1) a first strap portion having a proximal end coupled to the first end of the rail member and a distal end operatively coupled to the wall structure remote from the roof and (2) a second strap portion having a proximal end coupled to the second end of the rail member and a distal end operatively coupled to one of a ridgeline of the roof or another wall structure remote from the roof.

Therefore, a general object of this invention is to provide a solar module mounting apparatus that secures solar module mounting rails to a roof without any invasive fasteners penetrating roofing materials.

Another object of this invention is to provide a solar module mounting apparatus, as aforesaid, that secures respective mounting rails to a roof using a strap assembly secured to an exterior of a wall structure remote from the roof itself.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a solar module mounting apparatus according to a preferred embodiment of the present invention illustrated in use upon the roof of a building;

FIG. 2a is a side view of the solar module mounting apparatus as in FIG. 1;

FIG. 2b is an isolated view on an enlarged scale taken from FIG. 2a;

FIG. 3a is an end view of the solar module mounting apparatus as in FIG. 1;

FIG. 3b is an isolated view on an enlarged scale taken from FIG. 3b;

FIG. 4 is a perspective view of a solar module as in FIG. 1 removed from the building;

FIG. 5a is a side view of the solar module as in FIG. 4 illustrating the mounting flange;

FIG. 5b is an isolated view on an enlarged scale taken from FIG. 5a;

FIG. 6a is a perspective view of a rail member and strap assembly according to the present invention;

FIG. 6b is an isolated view on an enlarged scale taken from FIG. 6a;

FIG. 7a is a perspective view of the solar module and mounting flange as in FIG. 4 on an enlarged scale;

FIG. 7b is an isolated view on an enlarged scale taken from FIG. 7a;

FIG. 8a is a side view of a solar module and mounting flange coupled to a rail member;

FIG. 8b is a sectional view taken along line 8b-8b of FIG. 8a; and

FIG. 8c is an isolated view on an enlarged scale taken from FIG. 8b.

### DESCRIPTION OF THE PREFERRED EMBODIMENT

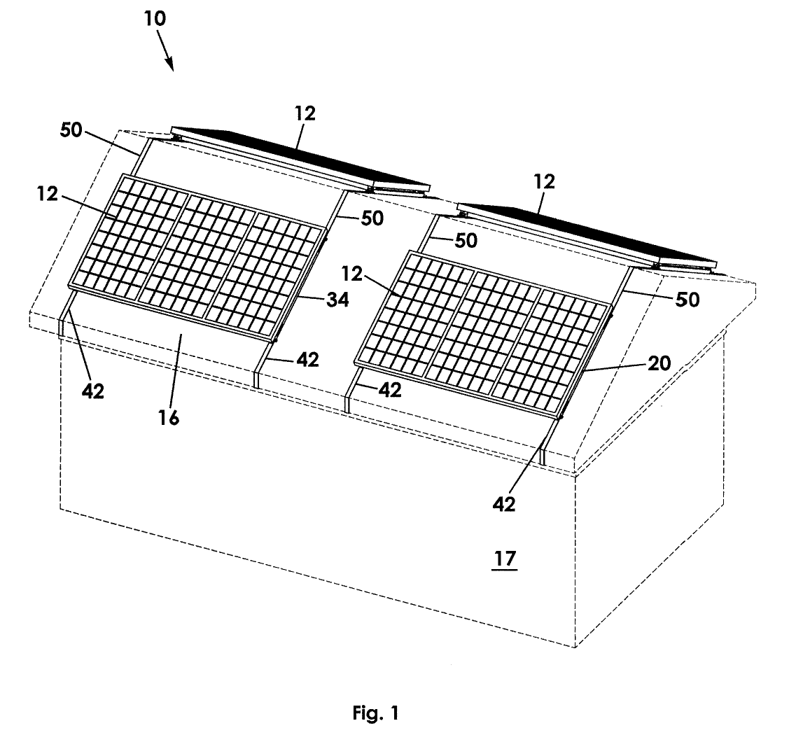

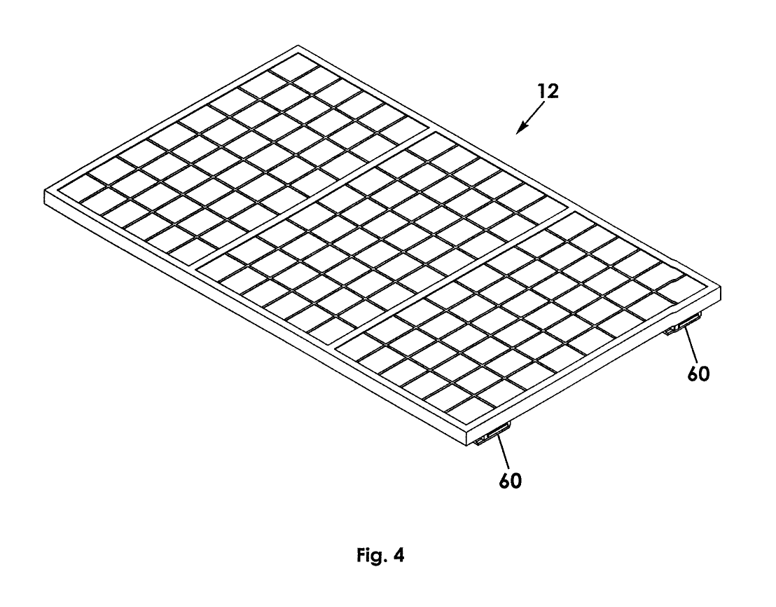

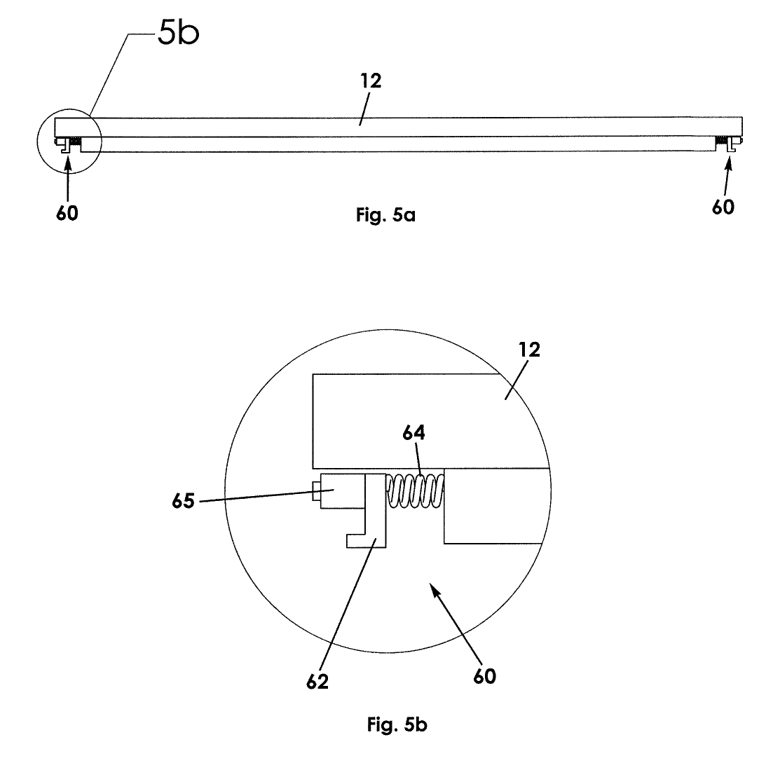

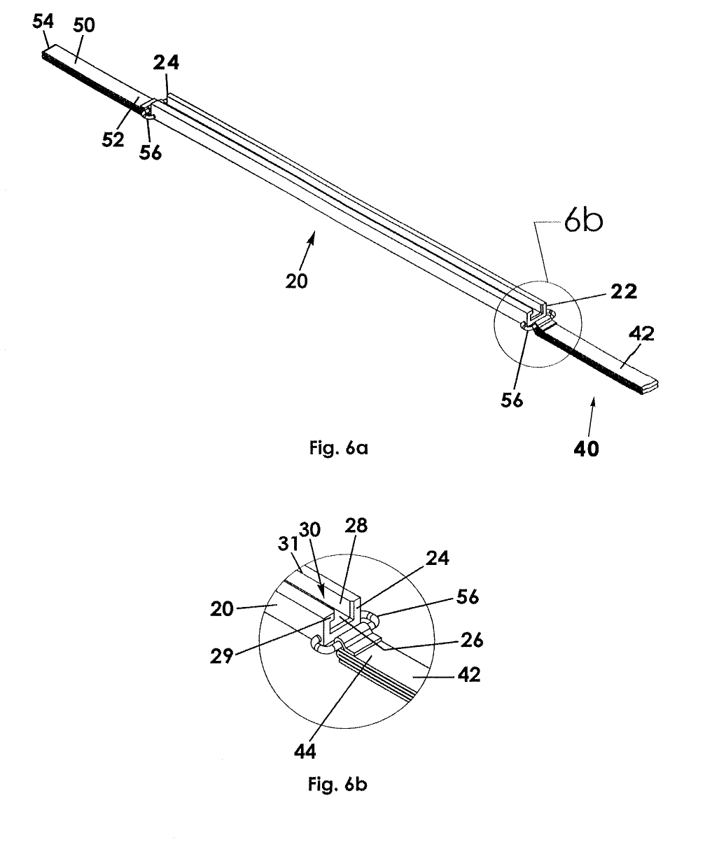

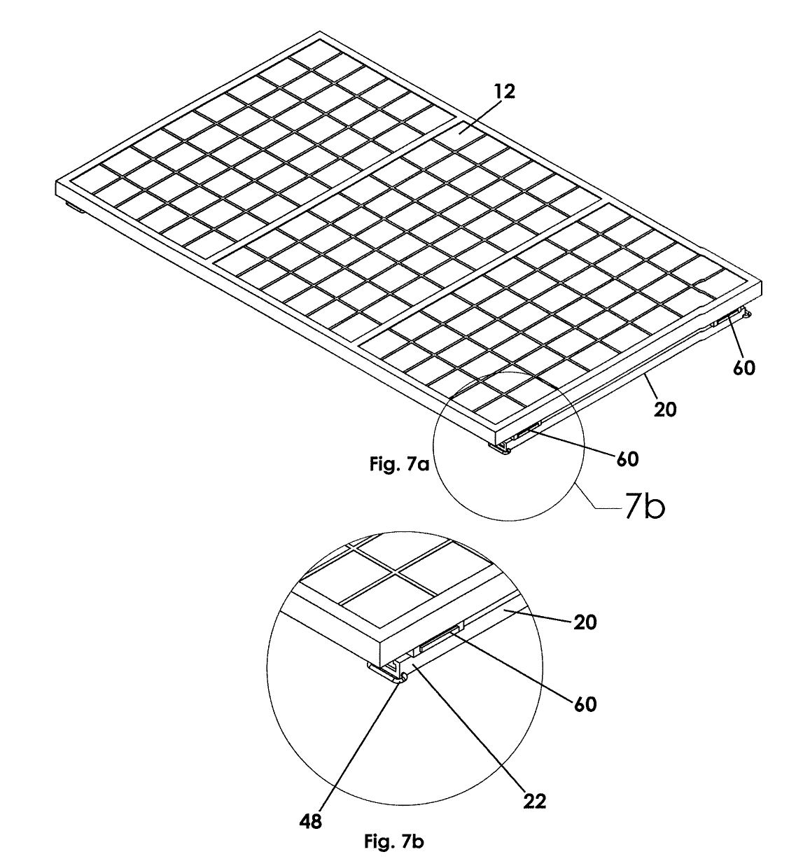

A solar module mounting apparatus according to a preferred embodiment of the present invention will now be described in detail with reference to FIGS. 1 to 8c of the accompanying drawings. The solar module mounting apparatus 10 includes a rail member 20 that interacts with a mounting flange 60 of a rooftop solar collection module 12 and a strap assembly for mounting to a rooftop 16. The mounting apparatus 10 is mounted with no invasive damage to the roof 16.

A rooftop solar collection module 12 (also referred to simply as a “solar module”) is selectively and releasably coupled to a rail member 20 or mounted atop multiple rail members 20 as may be desired for adequate support. More particularly, a rail member 20 has an elongate linear configuration having opposed first 22 and second 24 ends. The rail member 20 may be constructed of aluminum or other durable material. The rail member 20 includes a bottom wall 26 and a pair of spaced apart upstanding side walls 28 such that the rail member 20 defines a channel 30 configured to receive a mounting flange 60 of the solar module 12 as will be described further. The channel 30 has a generally U-shaped configuration such that the channel 30 is configured as a trough in which the mounting flange 60 is able to nest and slide to a desired position. In an embodiment, the first 22 and second 24 ends of the rail member 20 are open so that rain water does not accumulate in the channel 30 or that trash is not unduly accumulated in the channel 30. In addition, the bottom wall of the rail member 20 may include a non-slip surface—such as a rubber material or construction.

In an embodiment, the rail member 20 includes a tab 29 extending inwardly from a terminal or peripheral edge of one the upstanding side walls 28 so that the channel 30 defines a recessed area 32 configured to selectively receive a portion of a mounting flange 60 as will be described later. The tab 29 may extend longitudinally along the length of the rail member 20 but does not completely close the open top 31 thereof.

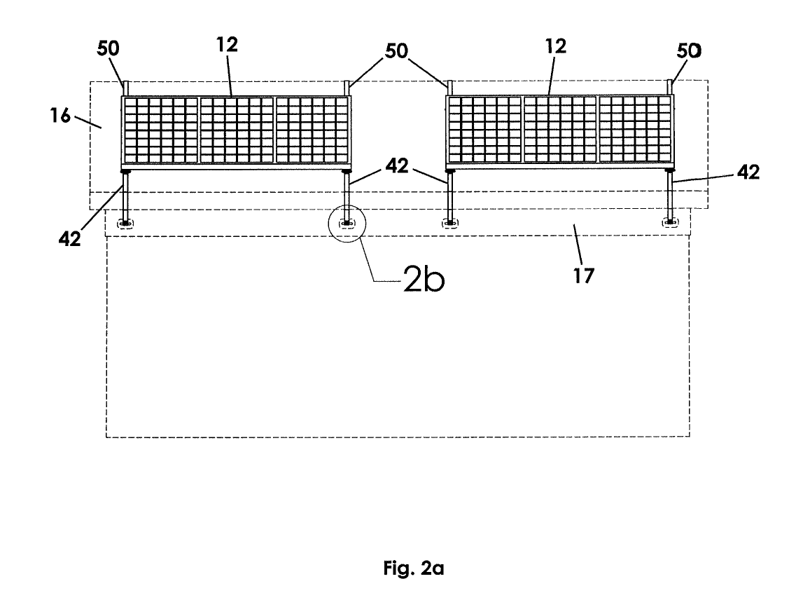

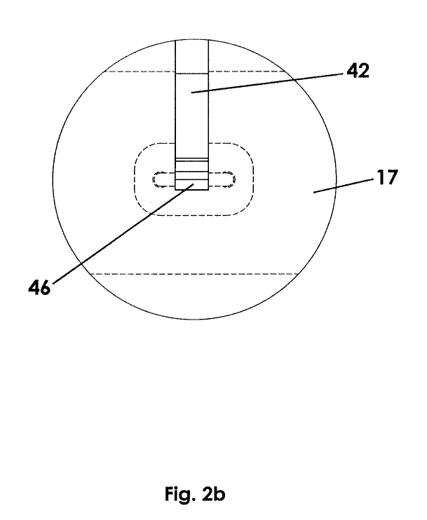

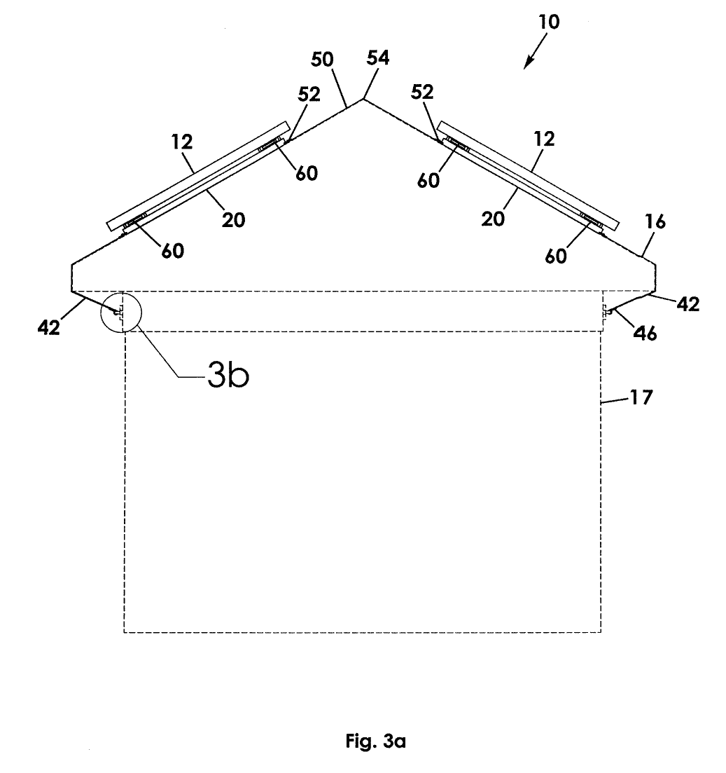

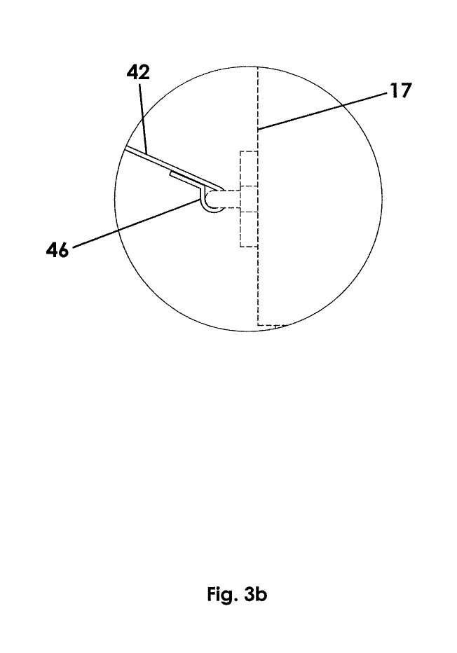

The strap assembly is coupled to ends of the rail member 20 in a manner such that the rail member 20 is mounted atop a rooftop 16 without need for any invasive fasteners being used that may cause damage and leakage. The strap assembly may be constructed of stainless steel material although a plastic coated galvanized material would also work. More particularly, the strap assembly includes a first strap portion 42 and a second strap portion 50. The first strap portion 42 includes a proximal end 44 coupled to the first end 22 of the rail member 20 and a distal end 46 operatively coupled to the exterior of a wall structure 17 of a residence or business. In an embodiment, the proximal end 44 of the first strap portion 42 may be coupled to the first end 22 of the rail member 20 with a fastener such as a collar 48a clasp, a clamp, a bolt, a pin, a rod, or the like. The distal end 46 of the first strap portion 42 may be coupled to a fastener mounted to the wall structure 17, the fastener being a U-bolt, D-ring, or the like (FIGS. 2b and 3b).

Similarly, a proximal end 52 of the second strap portion 50 may be coupled to the second end 24 of the rail member 20 with a fastener such as a collar 56, a clasp, a clamp, a bolt, a pin, a rod, or the like. The second strap portion 50 extends away from the distal end of the rail member 20. In one embodiment (not shown), the distal end 54 of the second strap portion 50 may be coupled to the ridgeline of the roof 16. Preferably, however, the elongate second strap portion 50 may extend atop the roof 16 all the way to the overhang or soffit thereof such that the distal end 54 may be coupled to a wall structure in the same or similar manner as described above regarding the distal end of the first strap portion 42.

Solar modules 12 are often mounted on both sides of a roof 16 (FIG. 1). In this instance, a first portion 42 of a strap assembly is utilized to secure respective proximal ends 44 of respective rail members 20 to respective wall structures 17 of the house or building. Then, a single second strap portion 50 may extend between respective distal ends 54 of respective rail members 20 (FIG. 1).

Many solar modules 12 are quite large. Therefore, it is recognized that more than one rail member 20 may be desirable to support a large solar module. As shown in FIG. 1, each solar module 12 may be supported by the rail member 20 and by an auxiliary rail member 34, the auxiliary rail member having a configuration identical or substantially similar to the rail member 20 first described above. With the present apparatus, multiple solar modules 12 may be positioned side by side and supported by an appropriate number of rail members 20 and auxiliary rail members 34. A corresponding auxiliary strap assembly identical or substantially similar to the strap assembly first described above may also be associated with the auxiliary rail member 34.

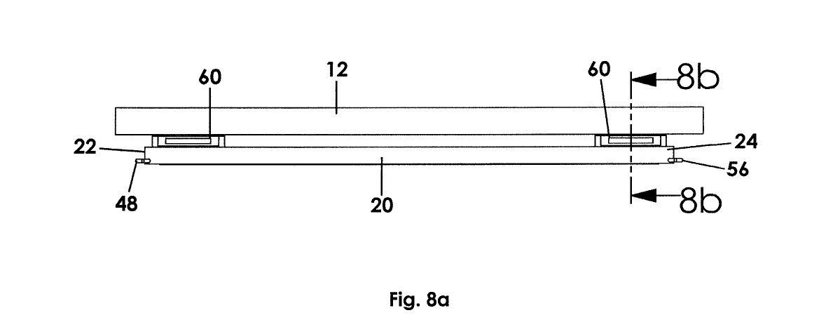

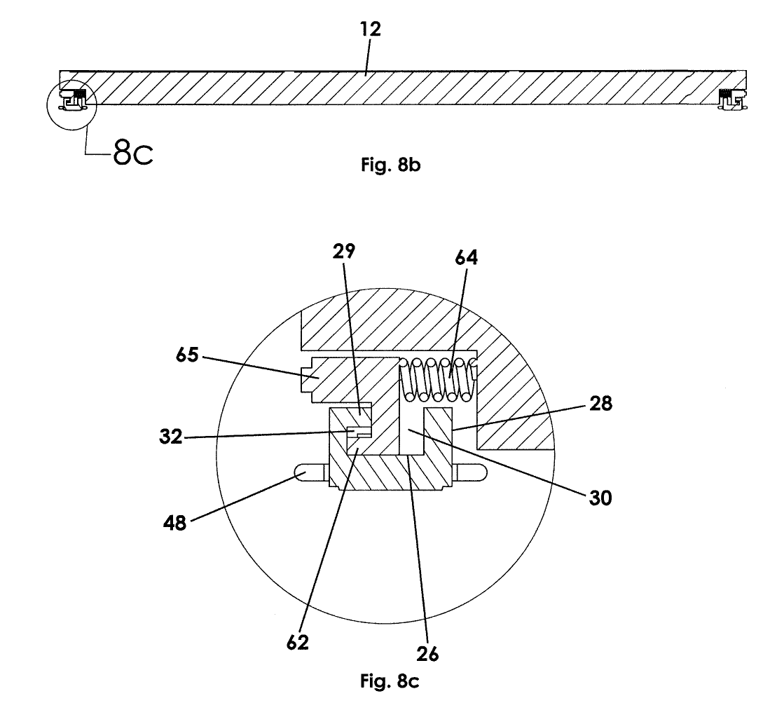

Now, the mounting flange 60 is used to couple a solar module 12 to a rail member 20 and will be described in greater detail. Each solar module 12 is associated with at least one and, preferably, a plurality of spaced apart mounting flange(s) 60. A mounting flange 60 may be coupled to or integrally constructed with a bottom of a solar module 12 (FIG. 8b).

The mounting flange 60 is situated in an inset area defined by an upstanding wall 14 of a lower portion of a solar module 12. Viewed as an integrated part of the solar module 12, the mounting flange 60 is the lower portion of a solar module 12 and itself defines the inset area (FIG. 8c). The mounting flange 60 includes a locking pin 62 having a dimension, size, and configuration that may be selectively received in the channel 30. The locking pin 62 is configured to enter the channel 30 via the open top thereof and then to be moved into the recessed area 32 and be locked therein by the tab 29. The mounting flange 60 includes a spring 64 having a first end coupled to coupled to the upstanding wall 14 and extending outwardly to a second end. The spring 64 may be a compression spring that is biased to normally extend outwardly away from the upstanding wall 14. The locking pin 62 is coupled or connected to the second end of the spring 64. The spring 64 is selectively movable, such as by the inward urging of a user of push button 65, between a compressed configuration in which the locking pin 62 is selectively received into or released from the channel 30 via the open top of the rail member 20 and a normally extended configuration at which the locking pin 62 is received into the recessed area 32 of the rail member 20 and at which the locking pin 62 is prevented from being released from the channel 30 via the open top 31 of the rail member 20.

In an embodiment, the locking pin 62 includes upper and lower sections configured to selectively mate with the tab 29 (i.e. surrounding two sides of the tab 29) of the rail member 20 when the spring 64 is allowed to move to the extended (uncompressed) configuration and locking pin 62 is nested in the channel 30 as described above.

In use, a resident of a home, contractor, energy consultant may determine a type and number of solar modules to mount atop the roof of the respective structure. Then, the number and placement of an appropriate number of rail members 20 atop the roof 16 may be determined. The rail members 20 may then be hoisted onto the roof and positioned generally in the positions desired. Selected first strap portions may then be coupled to respective first ends 22 of respective rail members 20 and likewise extended down the roof, around the soffit, and attached to respective fasteners on a wall of the structure. Likewise, respective second strap portions 50 may be coupled to respective second ends 24 of respective rail members 20 and extended over the ridge of the house and either coupled to another rail member 20 on the opposite side of the roof or extended down that side of the roof and coupled to an opposed wall structure as described above. When all rail members 20 have been attached in this manner, respective mounting flanges 60 of respective solar modules 12 may be engaged with respective channels 30 of respective rail members.

Accordingly, the solar modules are mounted to a rooftop with any invasive fasteners being inserted into the roof itself, thus preventing leakage either in the short term or long term.

It is understood that while certain forms of this invention have been illustrated and described, it is not limited thereto except insofar as such limitations are included in the following claims and allowable functional equivalents thereof.

1. A solar module mounting apparatus for use with a structure having a wall structure downwardly adjacent to and supporting a roof, said solar module comprising:
a solar collection module;
a rail member having an elongate linear configuration and having first and second ends, said rail member defining a channel extending between said first and second ends that defines an open top configured to selectively mate with the rooftop solar collection module;
a strap assembly that includes (1) a first strap portion having a proximal end coupled to said first end of said rail member and a distal end operatively coupled to a fastener displaced from and positioned under an overhang of the face of the roof and not penetrating the roof and (2) a second strap portion having a proximal end coupled to said second end of said rail member and a distal end operatively coupled to another fastener displaced from and positioned under an overhang of the face of the roof and not penetrating the roof;
wherein:
said proximal end of said first strap portion is coupled to said first end of said rail member with a fastener; and
said proximal end of said second strap portion is coupled to said first second end of said rail member with a fastener;
a mounting flange associated with the rooftop solar collection module displaced from said rail member that is operable to releasably mate with said channel of said rail member;
wherein:
said rail member includes a bottom wall and a pair of side walls extending upwardly from said bottom wall that, together, define said channel;
said rail member includes a tab extending inwardly from an upper peripheral edge of one of said pair of side walls such that said channel has a recessed area situated beneath said tab;
wherein said solar collection module defines an inset area having an upstanding wall and comprises:
a spring having a first end coupled to said upstanding wall and a second end opposed to said first end;
a locking pin having an upper section coupled to said second end of said spring and a lower section having an L-shaped configuration that is complementary to a configuration of said recessed area;
said spring being selectively movable between a compressed configuration in which said lower section of said locking pin is received into or released from said recessed area via said open top of said channel and a normally extended configuration in which said lower section of said locking pin is received into said recessed area of said rail member and not releasable from said channel.

2. (canceled)

3. The solar module mounting apparatus as in claim 1, wherein said distal end of said first strap portion is coupled to a U-bolt adjacent the roof and completely displaced from a face of the roof.

4. (canceled)

5. (canceled)

6. (canceled)

7. The solar module mounting apparatus as in claim 1, wherein said first and second ends of said rail member have an open configuration so as to enable rainwater to flow out of said channel.

8. (canceled)

9. The solar module mounting apparatus as in claim 1, wherein said bottom wall of said rail member includes a non-slip lower surface.

10. The solar module mounting apparatus as in claim 1, further comprising:
an auxiliary rail member having an elongate linear configuration and having first and second ends, said first rail member defining a channel extending between said first and second ends that defines an open top and open ends configured to selectively mate with the rooftop solar collection module;
an auxiliary strap assembly that includes (1) a first strap portion having a proximal end coupled to said first end of said auxiliary rail member and a distal end operatively coupled to the wall structure remote from the roof and (2) a second strap portion having a proximal end coupled to said second end of said auxiliary rail member and a distal end operatively coupled to another wall structure remote from the roof;
wherein said auxiliary rail member and said auxiliary strap assembly are laterally spaced apart from said rail member and said strap assembly, respectively, so as to, together, support the rooftop solar collection module upon the roof.

11-20. (canceled)
